(19) United States
(12) Patent Application Publication
(10) Pub. No.: US 2008/0070708 A1
(43) Pub. Date: Mar. 20, 2008

(54) Assembled camshaft having indentations extending underneath the slid-on components

(76) Inventors: Michael Brinkmann, Olpe (DE); Jochen Wolf, Quedlinburg (DE); Jochen Asbeck, Attendorn (DE); Rudiger Rossberger, Thale (DE)

Correspondence Address: WYATT, GERBER & O'ROURKE, 99 PARK AVENUE, NEW YORK, NY, 10016, US

(21) Appl. No.: 11/901,559

(22) Filed: Sep. 18, 2007

(30) Foreign Application Priority Data
Sep. 20, 2006 (DE) 10 2006 044 735.2

(51) Int. Cl. F16C 3/12; F01L 1/047; F16L 3/12

(52) U.S. Cl. 464/183; 29/888.1

(57) ABSTRACT

An assembled camshaft comprising a tubular shaft and a plurality of components each provided with a through-aperture, more particularly cams which have been slid on to the tubular shaft and are fixed thereon at a distance from one another, wherein, between the components, the tubular shaft comprises inwardly formed side indentations, wherein at least individual indentations extend underneath at least one of the components.

The invention relates to an assembled camshaft comprising a tubular shaft and a plurality of components each provided with a through-aperture, more particularly cams which have been slid on to the tubular shaft and are fixed thereon at a distance from one another, wherein, between the components, the tubular shaft comprises inwardly formed side indentations. Because of their lightweight properties and greater freedom regarding the selection of materials, camshafts of said type are used more and more frequently for high-performance engines.

The production method for assembled camshafts is described in the applicant's DE 102 05 540 C1 according to which the plastic deformation of individual longitudinal portions of the tubular shaft takes placed sequentially by applying locally a limited amount of internal hydraulic pressure to the tubular shaft inside the slid-on cams, and in the process there occurs cross-sectional widening of the tubular shaft in smooth cylindrical through-apertures of the cams in order to achieve press fits between the tubular shaft and the cams.

In the case of cylinder heads of two-camshaft engines the installation conditions in the cylinder head are oftenly restricted. The threadless bolt channels for receiving the cylinder head bolts are necessarily positioned close to the camshafts, so that, in a plan view of the cylinder head, said channels are partially covered by the camshafts. During the production process, it is necessary for the camshafts to be finish-mounted in the cylinder head before the cylinder head can be placed on to the cylinder crank housing and bolted thereto. In cylinder heads with the above-mentioned characteristics this is impossible because inaccessibility of the access to said threadless channels. Said access becomes accessible only by using special types of camshafts which comprise side indentations in the region of said bolt channels, which reduce the cross-section of the camshaft in said region fillet-like and permit the use of threading tools for the cylinder head bolts when the camshaft has already been mounted. This permits both the mounting of finished cylinder heads and also the retightening of cylinder head bolt without having to remove the camshafts.

From DE 201 16 112 U1 there is known a method of producing assembled camshafts with said indentations, according to which method first the tubular shaft is inserted without cams into a complete die which encloses the entire tubular member in a play-free way and in which there are guided individual punches. The punches, at their front ends, comprise semi-cylindrical formations which extend transversely to the longitudinal axis of the tubular member, wherein said front end can be introduced into the dies cavity. First, the punches are used to form the indentations in the tubular shaft inserted into the die, and the accurately fitting outer support conditions for the tubular shaft provided by the die ensures that there occur no bulges next to the indentations during the forming process. Thereafter, the cams are slid on to the tubular shaft which is provided with the indentations and whose cross-section is held by the die so as to remain substantially unchanged, with the cams then being fixed on the tubular shaft by prior art joining methods such as shrinking or pressing. The initially mentioned joining method for securing the cams by producing cross-sectional widening at the tubular member is not suitable for example because pressure probes for generating a high internal hydraulic pressure can no longer be introduced into the already deformed tube.

From U.S. Pat. No. 6,935,292 B2 there is known a method of the same type for producing assembled camshafts with said indentations wherein the indentations must not under any circumstances extend underneath the slid-on components such as cam and bearing sleeves. There have to be observed minimum axial distances between the individual components which result indirectly from the depth and directly from the width of the indentations.

It is therefore the object of the present invention to provide assembled camshafts of said type which, while ensuring an adequate depth of the side indentations in the tubular shaft, permit a closer arrangement of adjoining slid-on components The objective is achieved by an assembled camshaft comprising a tubular shaft and a plurality of components each provided with a through-aperture, more particularly cams which have been slid on to the tubular shaft and are fixed thereon at a distance from one another, wherein, between the components, the tubular shaft comprises inwardly formed side indentations wherein at least some of the indentations extend underneath at least one of the components. Optionally, individual indentations can also extend underneath two adjoining components arranged at a distance from one another. With the design proposed here it is possible to provide already finish-constructed camshafts with closely adjoining, slid-on components with additional local formations for providing free assembly spaces wherein the secure fixing of the already fixed components is not at risk.

According to a preferred embodiment it is proposed that at least some of the components, more particularly cams, are provided with integrally formed-on sleeve projections, more particularly bearing sleeves. The subject of the invention preferably refers to those cams in the case of which there are formed components whose overall seating length is increased, so that the fact that the indentations extend underneath the components does not lead to a reduction in the secure fixing conditions. On the contrary, overall, there is achieved an improvement as compared to individual cams without sleeve projections fixed on their complete axial length. The invention also includes components in the form of simple, smooth, cylindrical bearing sleeves.

Furthermore, it is proposed that the indentions extend exclusively underneath the respective sleeve projections at said components, which sleeve projections can consist of an integrally formed-on bearing sleeve.

Said sleeve projection, i.e. more particularly bearing sleeves for a friction bearing of the camshaft in the cylinder head are, as a rule, formed on on one side only at a component, more particularly at a cam.

Furthermore, it is proposed that, in the region of the components, the tubular shaft comprises cold-formed diameter enlargements for the purpose of fixing the components. As a result, it is possible to use the initially mentioned, preferred joining technology for the components by locally applying an axially limited high internal hydraulic pressure to the tubular shaft within a component. The resulting diameter enlargement can initially extend around the entire circumference of the tubular shaft along the entire axial length of a component consisting of a cam and sleeve projection and beyond same because the indentations in the region of the sleeve projection are preferably produced only subsequently.

Furthermore, it is proposed that the diameter enlargements cooperate with smooth cylindrical through-apertures in the components, extend concentrically relative to the tubular shaft and form a press fit together with the components, more particularly that the un-indented diameter enlargements after the production of the indentations, extend at least over the axial length of the cam of a component consisting of a cam and sleeve projection.

Furthermore, it is proposed that the side indentations extend transversely to the extension of the tubular shaft and, more particularly, that the indentations correspond to approximately semi-cylindrical passages of the tubular member, with the indentations at the inside of the tube extending approximately as far as the tube axis. Even in this case, with the preferred method of producing the indentations in the tubular shaft by hot-forming, there is obtained a product with the required secure firm fitting conditions for the cams on the tubular shaft. As far as their circumferential position is concerned, the indentations preferably are orientated in the same direction.

An embodiment of a longitudinal portion of an inventive camshaft will be explained below with reference to the drawings wherein

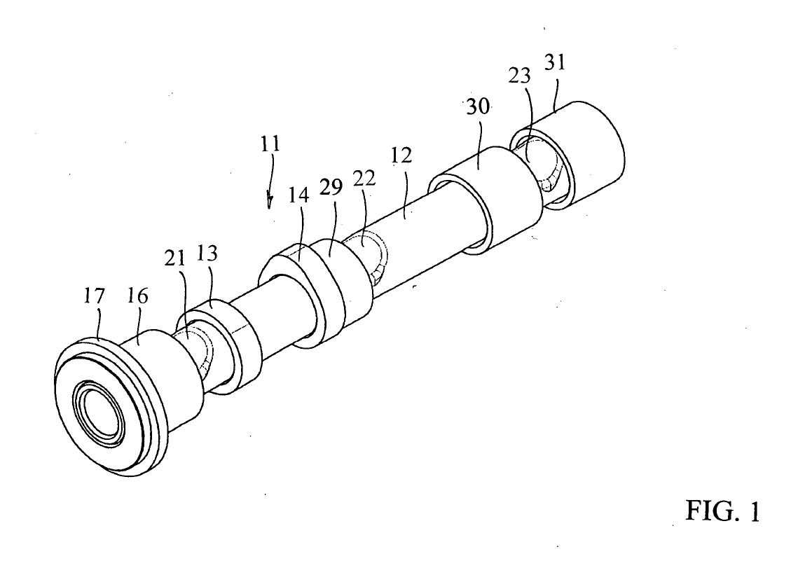

FIG. 1 shows a portion of an inventive assembled camshaft in an inclined view.

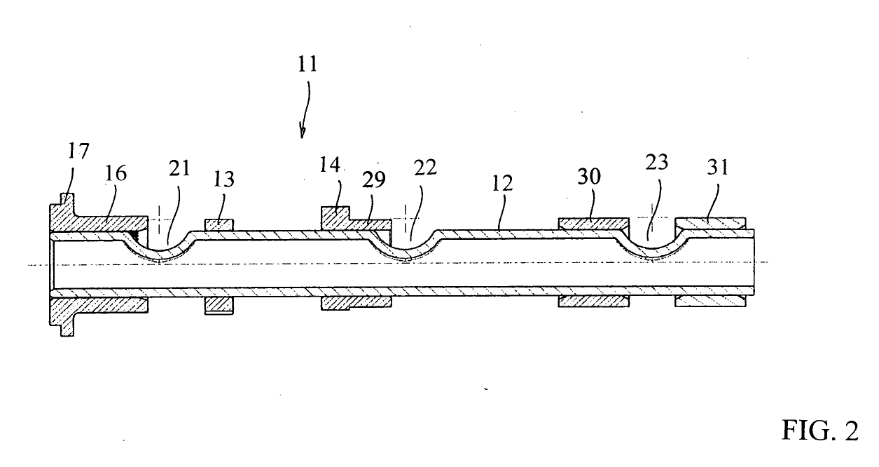

FIG. 2 shows the portion of the inventive assembled camshaft according to FIG. 1 in a longitudinal section.

The two illustrations of FIGS. 1 and 2 will be described jointly below. It is possible to identify an end portion of an assembled camshaft 11 which substantially consists of a tubular shaft 12 and elements or components slid on to same. The latter comprise cams 13, 14 which are secured on the tubular shaft 12 in different angular positions. For this purpose, the tubular shaft 12, in longitudinal portions associated with the cams 13, 14, is radially expanded by cold-forming, so that the cams 13, 14 are fixed by a press fit on axially delimited widened cross-sectional portions or diameter enlargements of the tubular shaft 12 which, in view of the present drawing scale, are not visible. In the same way, a bearing sleeve 16 is secured by a collar 17 on the tubular shaft 12 at the tube end, which bearing sleeve 16 can serve to fix a driving pinion. Such a driving pinion for driving the camshaft 11 can be attached, for example by press-fit, to the collar 17. Whereas the cam 13 has the standard shape of a disc, the cam 14 is formed so as to be integral with a bearing sleeve 29. Two bearing sleeves 30, 31 are secured on the tubular shaft 12 at a distance from the cams 13, 14 in the same way as the latter and are also spaced relative to one another. Indentations 21, 22, 23 are provided on to the tubular shaft 12 so as to adjoin the sleeve 16 and the sleeve 29 at the cam 14 and are arranged between the two bearing sleeves 30, 31. Said indentions 21, 22, 23 correspond to approximately semi-cylindrical passages of the tubular shaft, whose axes intersect the longitudinal axis of the camshaft 11 perpendicularly. The indentations 21, 22, 23 are orientated in the same direction with reference to their circumferential position, with the axes of the semi-cylindrical passages (which axes are not illustrated) being positioned perpendicularly relative to the drawing plane. The indentations 21, 22, 23 allow bolts and threading tools, whose axes extend perpendicularly relative to the drawing plane, to be moved very closely to the longitudinal axis of the camshaft 11. With some engine types, this is necessary for mounting a cylinder head when the camshaft is already fitted in the cylinder head.

A first indentation 21 is positioned between the bearing sleeve 16 and the first cam 13 and extends as far as, and underneath, the bearing sleeve 16. A second indentation 22 extends as far as, and underneath, the sleeve projection 29 of the second cam 14, along its entire axial length, being circumferentially fixed on the tubular shaft 12. Opposite the individual cam 13, the cam 14 with the bearing sleeve 29 in the way shown here is in contact via a larger seat face with the tubular shaft 12 and thus fits more securely on the tubular shaft 12 than the individual cam 13, irrespective of the indentation 22, which extends underneath the bearing sleeve 29. A third indentation 23 is located between the bearing sleeves 30, 31 and slightly extends underneath same. The axial length of the indentations 21, 22, 23 is largely determined by the depth required for the indentations. In accordance with the inventive design, the greatest depth of the indentations 21, 22, 23 can be located more closely to the components. In accordance with the invention, the indentations are not pressed in by hot-forming into the locally heated tubular member until the elements or components have been secured along their entire length as a result of the tubular member 12 having been subjected to a plastic cold-forming operation under a high internal pressure.

1. An assembled camshaft (11) comprising a tubular shaft (12) and a plurality of components each provided with a through-aperture, more particularly cams (13, 14) which have been slid on to the tubular shaft (12) and are fixed thereon at a distance from one another, wherein, between the components, the tubular shaft (12) comprises inwardly formed side indentations (22),
wherein
at least some of the indentations (21, 22, 23) extend as far as, and underneath, at least one of the components (16, 29, 30, 31).

2. A camshaft according to claim 1, wherein
at least one of the components further comprises at least one integrally formed-on sleeve projection.

3. A camshaft according to claim 1, wherein
the indentations (22) extend only underneath corresponding sleeve projections at the components.

4. A camshaft according to claim 1, wherein
the sleeve projections are formed-on the components on one side of the components.

5. A camshaft according to claim 1, wherein
the through-apertures are straight cylindrical apertures.

6. A camshaft according to claim 1, wherein
a portion of the tubular shaft (12) at a region of at least one of the components further comprises cold-formed diameter enlargements, whereby the components are fixed.

7. A camshaft according to claim 6, wherein
the diameter enlargements extend concentrically relative to the tubular shaft (12) and wherein the tubular shaft press-fits together with the through-apertures.

8. A camshaft according to claim 7, wherein
the diameter enlargements each extend at least over the axial length of one of the components.

9. A camshaft according to claim 1, wherein
the side indentations (21, 22, 23) are hot-formed indentations.

10. A camshaft according to claim 1, wherein
the indentations (21, 22, 23) are orientated in identical circumferential positions.

11. A method of producing an assembled camshaft comprising the steps of high-pressure internal deformation to fix at least one of the components on the tubular shaft (12), and subsequently providing indentations (21, 22, 23) on the tubular shaft (12).

12. A method according to claim 11, wherein
the indentations are provided extending as far as, and underneath, at least one of the components and further comprising a hot-forming process on the components locally heated portions of the tubular shaft (12).

13. The method according to claim 1 1, wherein the step of high-pressure internal deformation includes cold-forming of the tubular shaft (12).
